(19) United States
(12) Patent Application Publication
(10) Pub. No.: US 2019/0329735 A1
(43) Pub. Date: Oct. 31, 2019

(54) WIPER DEVICE

(71) Applicant: DENSO CORPORATION, Kariya-shi, Aichi (JP)

(72) Inventors: Yuuta IWASAKI, Kosai-city (JP); Takuji HAIJIMA, Toyohashi-city (JP); Hiroya OGASAWARA, Kosai-city (JP); Mitsuyoshi TOMIDA, Kosai-city (JP); Natsuto HAYAKAWA, Kosai-city (JP)

(73) Assignee: DENSO CORPORATION, Kariya-shi, Aichi (JP)

(21) Appl. No.: 16/343,488

(22) PCT Filed: Nov. 15, 2017
(86) PCT No.: PCT/JP2017/041140

§ 371 Date: Apr. 19, 2019

(30) Foreign Application Priority Data
Nov. 16, 2016 (JP) 2016-223588

(51) Int. Cl. B60S 1/08; B60S 1/34

(52) U.S. Cl. CPC B60S 1/0822; B60S 1/28; B60S 1/3425; B60S 1/0807

(57) ABSTRACT

A wiper device includes a wiper arm that includes a recess and that is swung due to rotation of a wiper motor, the wiper arm causes a wiper blade coupled to a leading end portion of the wiper arm to perform a wiping operation across a surface of a windshield glass, an acceleration sensor that is installed in the recess of the wiper arm, a drive circuit that generates a voltage to be applied to the wiper motor, and a control circuit that controls the drive circuit such that a voltage to reduce a change in acceleration of the wiper arm, detected by the acceleration sensor, is applied to the wiper motor.

### TECHNICAL FIELD

The present disclosure relates to a wiper device.

### BACKGROUND ART

In wiper devices in which a windshield glass is wiped by a wiper blade, the wiper blade sometimes vibrates with a shuddering motion during a wiping operation due to fluctuations in friction loading on the glass surface or fluctuations in the voltage from a battery configuring a power source. This vibration is referred to as “juddering”.

Such juddering not only impairs wiping of the windshield glass surface, but is also a distraction to vehicle occupants, and so it is strongly preferable that this phenomenon does not occur in wiper devices. In the past, in order to suppress or eliminate juddering, additional components have been provided as countermeasures, repeated adjustments have been made to equipment through trial and error, and the voltage applied to a wiper motor has been raised to increase the wiping speed.

However, with such trial and error it takes time and effort to produce the desired results, and when the voltage applied to the wiper motor is raised, the wiping operation becomes erratic, and issues arise such as the wiper blade overrunning a return position.

Japanese Patent Application Laid-Open (JP-A) Nos. H08-290756 and H10-194090 and Japanese National-Phase Publication No. 2003-513852 disclose technology in which juddering is detected by an acceleration sensor, and the rotation speed of a wiper motor is controlled according to the magnitude of the juddering so as to suppress the juddering.

### SUMMARY OF INVENTION

### Technical Problem

In the technology disclosed in JP-A No. H08-290756, the attachment position of the acceleration sensor is at a leading end of a wiper blade. However, the attachment direction of the sensor is not made clear, and in practice, attachment of the acceleration sensor to the leading end of the wiper blade and routing of wiring from the sensor would be difficult.

In the technology disclosed in JP-A No. H10-194090, a juddering component is detected based on a motor current, this being current in a wiper motor coil, and signals from a vibration sensor. However, the direction of the juddering component that is detected is not made clear.

In the technology disclosed in Japanese National-Phase Publication No. 2003-513852, although the acceleration sensor is attached to a wiper arm or wiper linkage, there is no consideration given to the fact that output signals from the acceleration sensor differ greatly according to the manner of attachment, and the manner in which an output signal from the acceleration sensor is utilized as a control signal for the wiper motor is not made clear.

In consideration of the above circumstances, an object of the present disclosure is to provide a wiper device installed with an acceleration sensor at an optimal position for suppressing vibration.

### Solution to Problem

In order to resolve the above issues, a wiper device of a first aspect of the present disclosure includes a wiper arm that includes a recess, that is swung due to rotation of a wiper motor, and that causes a wiper blade coupled to a leading end portion of the wiper arm to perform a wiping operation across a surface of a windshield glass, an acceleration sensor that is installed in the recess of the wiper arm, a drive circuit that generates a voltage to be applied to the wiper motor, and a control circuit that controls the drive circuit such that a voltage to reduce a change in acceleration of the wiper arm, detected by the acceleration sensor, is applied to the wiper motor.

In the wiper device of the first aspect, the acceleration sensor is installed in the recess inside the wiper arm, and juddering of the wiper blade is suppressed by generating a voltage to reduce the change in acceleration of the wiper arm, detected by the acceleration sensor, and applying this voltage to the wiper motor. The recess inside the wiper arm is isolated from the exterior, and is located at a position enabling easy detection of the change in acceleration of the wiper arm due to vibration of the wiper arm. The acceleration sensor can therefore be installed at an optimal position for suppressing vibration.

A wiper device of a second aspect of the present disclosure is the wiper device of the first aspect, wherein the control circuit controls the drive circuit such that the voltage applied to the wiper motor is a voltage with a waveform of opposite phase to a waveform of the change in acceleration detected by the acceleration sensor.

In the wiper device of the second aspect, juddering of the wiper blade can be suppressed by generating a voltage with a waveform of opposite phase to the waveform of the change in acceleration of the wiper arm detected by the acceleration sensor, and applying this voltage to the wiper motor.

A wiper device of a third aspect of the present disclosure is the wiper device of the first aspect or the second aspect, wherein the recess is open along a length direction of the wiper arm at a side facing the windshield glass.

In the wiper device of the third aspect, the recess in which the acceleration sensor is installed is closed off at faces on the sides and in the direction of progress of the vehicle (the front), such that the acceleration sensor is sheltered from the exterior.

A wiper device of a fourth aspect of the present disclosure is the wiper device of the third aspect, further including a member that blocks an opening of the recess.

In the wiper device of the fourth aspect, the recess in which the acceleration sensor is installed is blocked, thereby enabling the acceleration sensor to be protected from wind, rain, and the like.

A wiper device of a fifth aspect of the present disclosure is the wiper device of the first aspect to the fourth aspect, wherein the acceleration sensor detects acceleration of the wiper arm arising in a direction intersecting a length direction of the wiper arm.

In the wiper device of the fifth aspect, the direction of acceleration detection by the acceleration sensor is aligned with the swing direction of the wiper arm, thereby enabling the acceleration sensor to be installed at an optimal position for suppressing juddering of the wiper blade.

A wiper device of a sixth aspect of the present disclosure is the wiper device of the first aspect to the fifth aspect, wherein a signal wire that is covered by a protective member configured by an elastic body is connected to the acceleration sensor, is routed through the recess, extends outside the recess in a state covered by the protective member at a base portion of the wiper arm serving as a pivot point during swinging of the wiper arm, and is connected to the control circuit.

In the wiper device of the sixth aspect, the signal wire of the acceleration sensor is covered by the protective member and is thereby protected from the exterior.

A wiper device of a seventh aspect of the present disclosure is the wiper device of the sixth aspect, wherein the wiper arm includes a foldable hinge located between the base portion and the leading end portion, the acceleration sensor is installed in the recess between the base portion and the leading end portion, and the protective member and the signal wire extend from the acceleration sensor past the hinge and the base portion to outside the recess. The protective member and the signal wire have a length enabling a placement direction inside the recess to change due to folding at the hinge or swinging of the wiper arm.

In the wiper device of the seventh aspect, the signal wire and the protective member are routed with optimized lengths in the wiper arm including the hinge for performing what is referred to as lock-back, such that the signal wire of the acceleration sensor does not snap due to folding at the hinge or swinging of the wiper arm.

A wiper device of an eighth aspect of the present disclosure is the wiper device of the sixth aspect or the seventh aspect, wherein an overall length of the signal wire is longer than an overall length of the protective member.

In the wiper device of the eighth aspect, making the length of the signal wire longer than the length of the protective member prevents the signal wire inside the protective member from snapping when the protective member is folded.

A wiper device of a ninth aspect of the present disclosure is the wiper device of the sixth aspect to the eighth aspect, wherein an end portion of the signal wire covered by the protective member includes a connector that is connected to a signal wire extending from the control circuit, the connector includes an air hole that is in communication with an interior space within the protective member, and the interior space within the protective member is configured such that air is capable of passing through the air hole.

In the wiper device of the ninth aspect, the connector disposed at an end of the signal wire and the protective member is provided with the air hole that is in communication with the interior space of the protective member. This suppresses pressure changes in the interior space within the protective member due to folding and extension of the protective member or due to changes in temperature, thereby preventing the protective member from being damaged as a result of pressure changes in the interior space.

### BRIEF DESCRIPTION OF DRAWINGS

FIG. 1 is a schematic diagram illustrating configuration of a wiper device according to an exemplary embodiment of the present invention.

FIG. 2 indicates configuration diagrams illustrating operation of a wiper device according to an exemplary embodiment of the present invention.

FIG. 3 is a block diagram schematically illustrating an example of configuration of a wiper control circuit according to an exemplary embodiment of the present invention.

FIG. 4 is a schematic diagram illustrating an example of configuration of a driver's seat side wiper arm according to an exemplary embodiment of the present invention.

FIG. 5 is a schematic diagram looking onto the driver's seat side wiper arm illustrated in FIG. 4 from the arrow A direction.

FIG. 6A is a cross-section of a wiper arm, illustrating an example in which an acceleration sensor has been installed such that an acceleration detection direction of the acceleration sensor is parallel to the surface of a windshield glass.

FIG. 6B is a cross-section of a wiper arm, illustrating an example in which an acceleration sensor has been installed such that an acceleration detection direction of the acceleration sensor is perpendicular to the surface of a windshield glass.

FIG. 6C is a cross-section of a wiper arm, illustrating an example in which an acceleration sensor has been installed such that an acceleration detection direction of the acceleration sensor is inclined by an angler η with respect to the surface of a windshield glass.

FIG. 7 is a schematic diagram illustrating an example of a protective cover internally housing a sensor signal wire, and an example of connectors.

FIG. 8 is a schematic diagram illustrating an example of a juddering waveform, and an example of a voltage waveform applied to a wiper motor in order to suppress this juddering.

FIG. 9 is a flowchart illustrating an example of juddering suppression processing in a wiper device according to an exemplary embodiment of the present invention.

### DESCRIPTION OF EMBODIMENTS

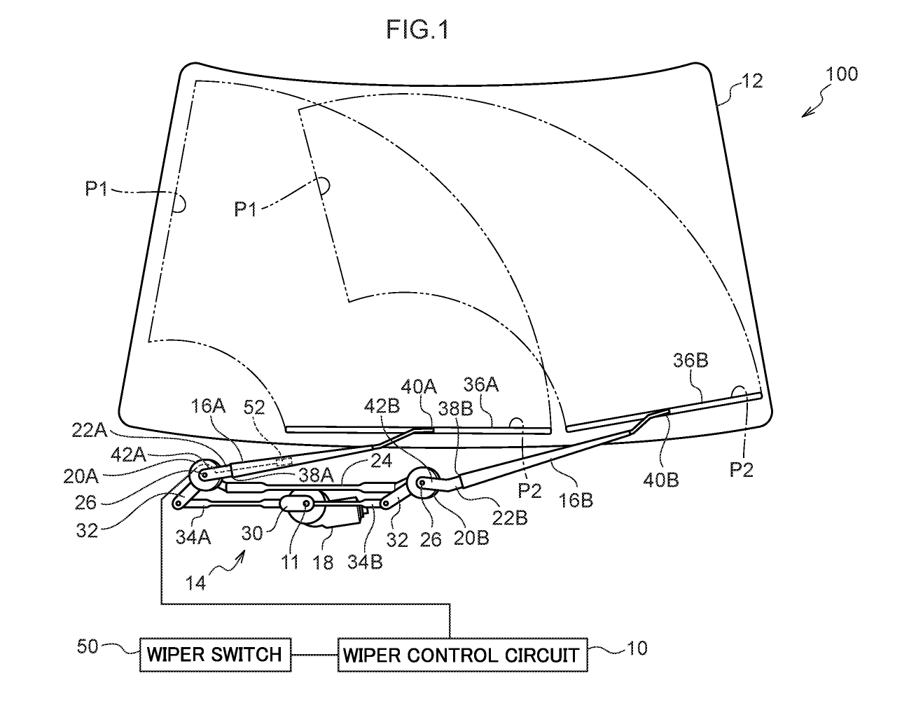

FIG. 1 is a schematic diagram illustrating configuration of a wiper device 100 according to an exemplary embodiment. The wiper device 100 is, for example, a device for wiping a windshield glass 12 provided to a vehicle such as a passenger car, using wiper blades 36A, 36B.

As illustrated in FIG. 1, the wiper device 100 includes a wiper motor 18, a link mechanism 14, and two wiper arms 16A, 16B. The wiper motor 18 drives rotation of a non-illustrated rotation shaft to drive rotation of an output shaft 11 through a speed reduction mechanism, configured by a non-illustrated worm gear and the like. The link mechanism 14 converts the rotational drive of the output shaft 11 into to-and-fro movement of two link rods 34A, 34B, described later. Base portions 42A, 42B of the wiper arms 16A, 16B are coupled to rotation shafts 26 that rotate in coordination with the to-and-fro movement of the link rods 34A, 34B. The wiper arms 16A, 16B are swung by rotation of the rotation shafts 26 such that wiper blades 36A, 36B coupled to leading end portions 40A, 40B of the wiper arms 16A, 16B are each moved to-and-fro between an upper return position P1 and a lower return position P2 on the windshield glass 12. Note that, in the following description, when there is no particular distinction to be made, the wiper arms 16A, 16B are collectively referred as wiper arms 16, and the wiper blades 36A, 36B are collectively referred as wiper blades 36.

The wiper arms 16A, 16B respectively include hinges 38A, 38B near to the rotation shafts 26 so as to allow lock-back of the wiper arms 16A, 16B. In the present exemplary embodiment, the wiper arms 16A, 16B can be folded toward an outside of the vehicle at the hinges 38A, 38B. An acceleration sensor 52 that detects acceleration of the wiper arm 16A is provided in a recess inside the wiper arm 16A provided on a driver's seat side. The acceleration sensor 52 is connected to a wiper control circuit 10, described later.

The wiper arms 16A, 16B are coupled to pivots 22A, 22B that are rotatably retained by pivot holders 20A, 20B. The pivot holders 20A, 20B are coupled to and retained by a retaining member 24. Note that when there is no particular distinction to be made, the pivot holders 20A, 20B are collectively referred as pivot holders 20, and the pivots 22A, 22B are collectively referred as pivots 22 in the following description.

The link mechanism 14 according to the present exemplary embodiment is a parallel motion link mechanism for moving the two wiper blades 36A, 36B coupled to the leading end portions 40A, 40B of the respective wiper arms 16A, 16B parallel to each other in the same direction at the same time.

The link mechanism 14 includes a crank arm 30 and the two link rods 34A, 34B. One end of the crank arm 30 is coupled to the output shaft 11 such that the crank arm 30 rotates integrally with the output shaft 11. One end of each the link rods 34A, 34B is rotatably coupled to another end of the crank arm 30, and another end of each the link rods 34A, 34B is coupled to the corresponding pivot 22A or 22B through a connecting member 32. Note that when there is no particular distinction to be made, the link rods 34A, 34B are collectively referred as link rods 34 in the following description.

The wiper control circuit 10 that controls rotation of the wiper motor 18 is connected to the wiper motor 18. The wiper control circuit 10 according to the present exemplary embodiment controls the rotation speed of the wiper motor 18 based on a command signal for a rotation speed corresponding to a mode selection position of a wiper switch 50, described later.

As described above, the wiper motor 18 according to the present exemplary embodiment includes the speed reduction mechanism, and so the rotation speed and rotation angle of the output shaft 11 are not the same as the rotation speed and rotation angle of a main body of the wiper motor. However, since the main body of the wiper motor and the speed reduction mechanism are integral to one another and indivisible in the present exemplary embodiment, the rotation speed and rotation angle of the output shaft 11 are considered synonymous with the rotation speed and rotation angle of the wiper motor 18.

The wiper switch 50 switches ON or OFF power supplied to the wiper motor 18 from a vehicle battery, configuring a power source, and is connected to the wiper control circuit 10. The wiper switch 50 is capable of switching between a low speed operation mode selection position in which the wiper blades 36A, 36B are operated at low speed, a high speed operation mode selection position in which the wiper blades 36A, 36B are operated at high speed, an intermittent operation mode selection position in which the wiper blades 36A, 36B are operated intermittently at fixed intervals, and a stow (stationary) mode selection position. Command signals for rotation speeds corresponding to the respective mode selection positions are output to the wiper control circuit 10.

When a signal corresponding to a mode selection position is output from the wiper switch 50 and input to the wiper control circuit 10, the wiper control circuit 10 performs control corresponding to the signal output from the wiper switch 50. The wiper control circuit 10 also detects juddering of the wiper blade 36A based on a signal output from the acceleration sensor 52 provided at the wiper arm 16A. In cases in which juddering has been detected, the wiper control circuit 10 controls a voltage supplied to the wiper motor 18 so as to suppress the juddering.

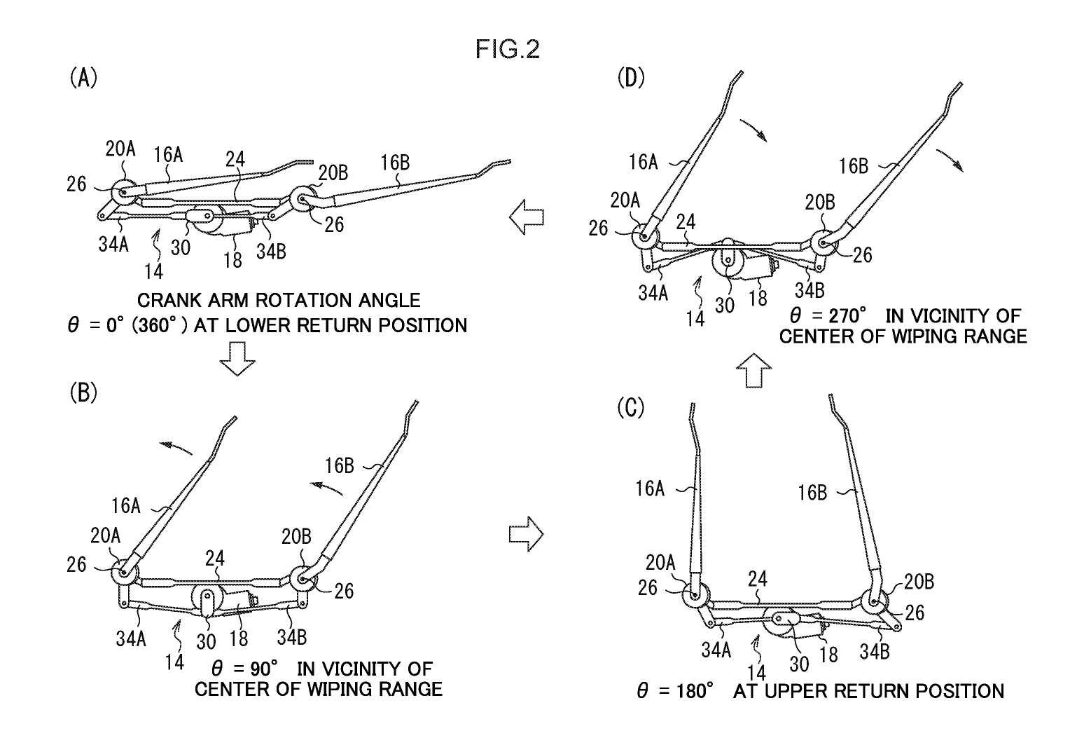

FIG. 2(A) to FIG. 2(D) are configuration diagrams illustrating operation of the wiper device 100 according to the present exemplary embodiment. As illustrated in FIG. 2(A) to FIG. 2(D), the crank arm 30 rotates integrally with rotation of the output shaft 11. The other ends of the link rods 34A, 34B move to-and-fro due to the rotation of the crank arm 30, so as to make one to-and-fro movement for every one full rotation of the crank arm 30. The pivots 22A, 22B are pivoted to-and-fro about the respective rotation shafts 26 by the to-and-fro movement of the link rods 34A, 34B. The wiper blades 36A, 36B move to-and-fro in coordination with the to-and-fro pivoting of the pivots 22A, 22B.

Note that in the link mechanism 14 according to the present exemplary embodiment, the crank arm 30 and the link rods 34A, 34B form a straight line at rotation angles where the crank arm 30 is horizontal, and these rotation angles correspond to return positions at which the movement direction of the link rods 34A, 34B is reversed.

As illustrated in FIG. 2(A), in cases in which the crank arm 30 is at a horizontal rotation angle on the left side of the output shaft 11, the wiper blades 36 are each positioned at the lower return position P2. As illustrated in FIG. 2(C), in cases in which the crank arm 30 is at a horizontal rotation angle on the right side of the output shaft 11, the wiper blades 36 are each positioned at the upper return position P1. Note that in the present exemplary embodiment, as illustrated in FIG. 2(A), the horizontal rotation angle where the crank arm 30 is on the left side of the output shaft 11 serves as a reference (θ=0°) for a rotation angle θ of the crank arm 30.

As described above, in the present exemplary embodiment, the wiper device 100 is configured such that the wiper blades 36 move to-and-fro between the lower return position P2 and the upper return position P1 for every one full rotation of the output shaft 11 of the wiper motor 18. However, the present exemplary embodiment is not limited thereto. Configuration may be such that the wiper motor 18 is capable of rotating forward and rotating in reverse by a predetermined rotation angle under the control of the wiper control circuit 10. Thus, when the output shaft 11 is rotated forward by the predetermined rotation angle, the wiper blades 36 move from the lower return position P2 to the upper return position P1, and when the output shaft 11 is rotated in reverse by the predetermined rotation angle after having been rotated forward by the predetermined rotation angle, the wiper blades 36 move from the upper return position P1 to the lower return position P2.

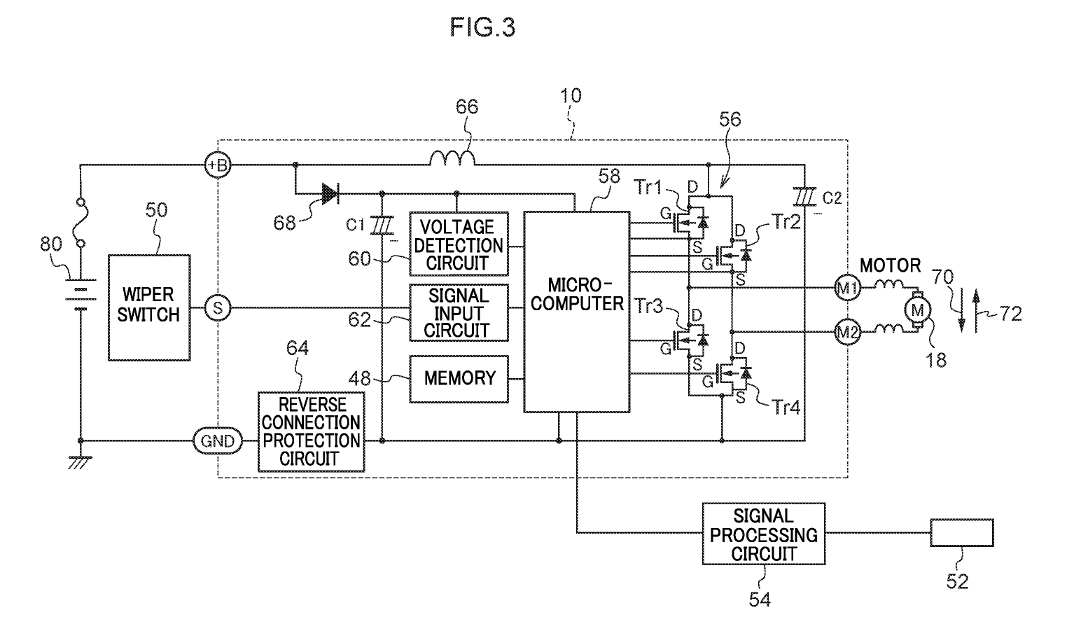

FIG. 3 is a block diagram schematically illustrating an example of configuration of the wiper control circuit 10 according to the present exemplary embodiment. As an example, the wiper motor 18 illustrated in FIG. 3 is a brushed DC motor.

The wiper control circuit 10 illustrated in FIG. 3 includes a drive circuit 56 that generates a voltage for application to a coil terminal of the wiper motor 18, and a microcomputer 58 that controls ON and OFF switching of switching elements configuring the drive circuit 56. Power from a battery 80 is supplied to the microcomputer 58 through a diode 68. A voltage detection circuit 60 provided between the diode 68 and the microcomputer 58 detects the voltage of the supplied power, and outputs a detection result to the microcomputer 58. An electrolytic capacitor C1 is provided with one terminal connected between the diode 68 and the microcomputer 58, and another terminal (−) connected to ground. The electrolytic capacitor C1 is a capacitor for stabilizing the power source of the microcomputer 58. For example, the electrolytic capacitor C1 protects the microcomputer 58 by accumulating a sudden high voltage such as a surge, and acting as a bypass to ground.

A signal from the wiper switch 50 for instructing the rotation speed of the wiper motor 18 is input to the microcomputer 58 through a signal input circuit 62. Since the signals output from the wiper switch 50 are analogue signals, the signals are digitalized by the signal input circuit 62 and then input to the microcomputer 58.

The microcomputer 58 controls the drive circuit 56 using a program stored in memory 48, and changes the voltage applied to the wiper motor 18 so as to suppress juddering.

As illustrated in FIG. 3, the drive circuit 56 employs transistors Tr1, Tr2, Tr3, and Tr4, these being N-type field-effect transistors (FETs), as switching elements. The drains of the transistor Tr1 and the transistor Tr2 are both connected to the battery 80 through a noise prevention coil 66, and the sources of the transistor Tr1 and the transistor Tr2 are respectively connected to the drains of the transistor Tr3 and the transistor Tr4. The sources of the transistor Tr3 and the transistor Tr4 are connected to ground.

The source of the transistor Tr1 and the drain of the transistor Tr3 are connected to one coil terminal of the wiper motor 18, and the source of the transistor Tr2 and the drain of the transistor Tr4 are connected to the other coil terminal of the wiper motor 18.

The transistor Tr1 and the transistor Tr4 are switched ON by a high level signal being input to the gates of the transistor Tr1 and the transistor Tr4, and a CW current 70 flows in the wiper motor 18 so as to rotate the crank arm 30 together with rotation of the output shaft 11, as illustrated in FIG. 2(A) to FIG. 2(D). Furthermore, the voltage of the CW current 70 can be modulated by using Pulse Width Modulation (PWM) control to switch one out of the transistor Tr1 or the transistor Tr4 ON and OFF rapidly while the other out of the transistor Tr1 or the transistor Tr4 is ON.

As described above, in the present exemplary embodiment, when the output shaft 11 of the wiper motor 18 makes one full rotation, the wiper blades 36A, 36B move to-and-fro between the lower return position P2 and the upper return position P1. In configurations in which the wiper blades 36 move from the lower return position P2 to the upper return position P1 when the output shaft 11 rotates forward by a predetermined rotation angle, and the wiper blades 36 move from the upper return position P1 to the lower return position P2 when the output shaft 11 rotates in reverse by the predetermined rotation angle after having rotated forward by the predetermined rotation angle, a CCW current 72 that rotates the output shaft 11 and a crank arm in the opposite direction to that in FIG. 2(A) to FIG. 2(D) also needs to be generated.

The CCW current 72 is generated by inputting a high level signal to the gates of the transistor Tr2 and the transistor Tr3. Furthermore, the voltage of the CCW current 72 can be modulated using PWM control to switch one out of the transistor Tr2 or the transistor Tr3 ON and OFF rapidly while the other out of the transistor Tr2 or the transistor Tr3 is ON.

In the present exemplary embodiment, a reverse connection protection circuit 64 and the noise prevention coil 66 are provided between the battery 80 configuring the power source and the drive circuit 56, and an electrolytic capacitor C2 is provided in parallel to the drive circuit 56. The noise prevention coil 66 is an element for suppressing noise generated by the switching of the drive circuit 56.

The electrolytic capacitor C2 is an element for dampening noise generated by the drive circuit 56 and for preventing an excessive current from being input to the drive circuit 56 when at high voltage by accumulating a sudden high voltage such as a surge, and acting as a bypass to ground.

The reverse connection protection circuit 64 is a circuit for protecting the devices configuring the wiper control circuit 10 if the positive electrode and the negative electrode of the battery 80 are connected in the opposite manner to that illustrated in FIG. 3. As an example, the reverse connection protection circuit 64 is configured by what is referred to as a diode-connected FET in which the drain and the gate of the FET are connected to each other.

The acceleration sensor 52 provided at the wiper arm 16A is connected to the microcomputer 58 through a signal processing circuit 54. In cases in which signals output from the acceleration sensor 52 are analogue signals, the signals are digitalized by the signal processing circuit 54 and then input to the microcomputer 58. In cases in which juddering has been detected by the acceleration sensor 52, the microcomputer 58 performs PWM control of the drive circuit 56 so as to modulate the voltage applied to the wiper motor 18 and suppress the juddering.

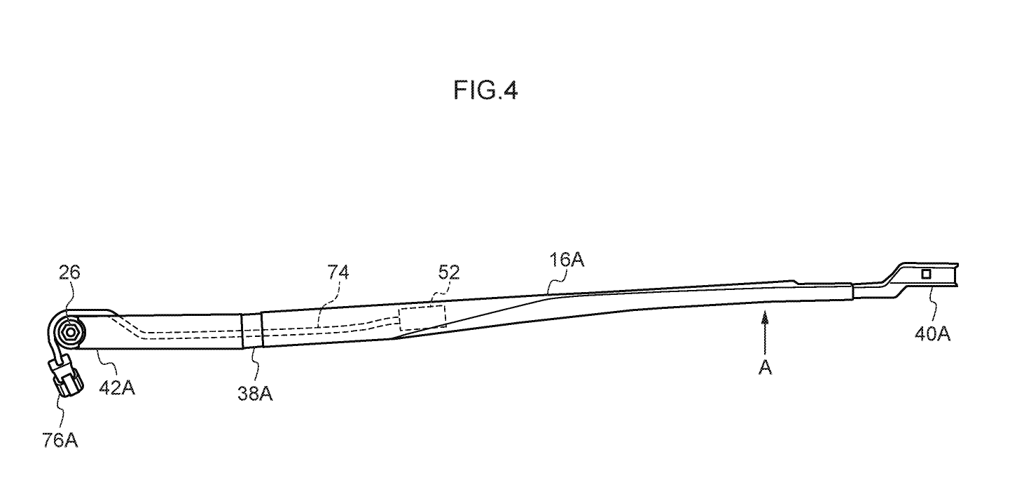

FIG. 4 is a schematic diagram illustrating an example of configuration of the driver's seat side wiper arm 16A according to the present exemplary embodiment. As illustrated in FIG. 4, the acceleration sensor 52 is provided in a space inside the wiper arm 16A between the hinge 38A and the leading end portion 40A. A tube-shaped protective cover, internally housing a sensor signal wire, extends together with the sensor signal wire from the acceleration sensor 52 as far as the base portion 42A that configures a pivot point during swinging of the wiper arm 16A. A connector 76A that is connected to a connector (not illustrated in the drawings) on the wiper control circuit 10 side is provided at an end of the sensor signal wire.

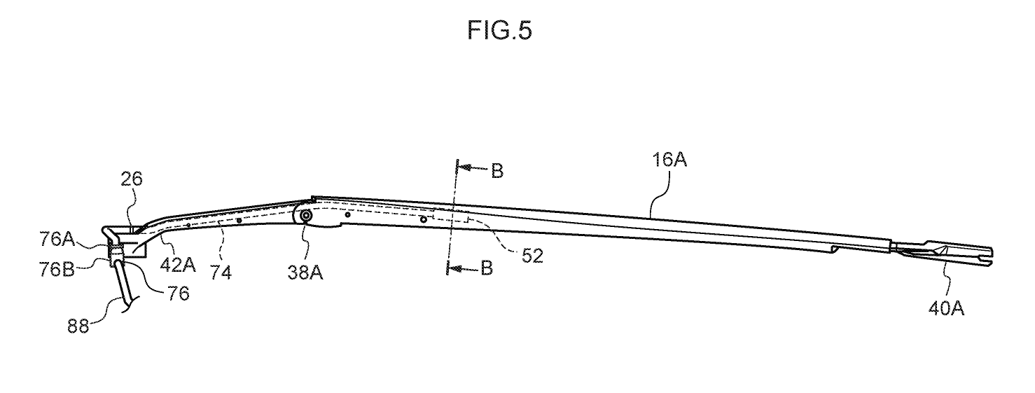

FIG. 5 is a schematic diagram looking onto the driver's seat side wiper arm 16A illustrated in FIG. 4 from the arrow A direction. The acceleration sensor 52 is provided between the hinge 38A and the leading end portion 40A. A cross-section of the wiper arm 16A in a direction orthogonal to the length direction, illustrated by arrows B, exhibits a substantially U-shaped profile. A recess open toward a side facing the windshield glass 12 is thereby formed in the wiper arm 16A. A bottom face of the recess is flat, and this bottom face is coupled to the corresponding rotation shaft 26 so as to run parallel to the surface of the windshield glass 12.

In the present exemplary embodiment, the space inside the wiper arm 16A where the acceleration sensor 52 and the sensor signal wire covered by the protective cover 74 are provided is configured by a recess open toward the side facing the windshield glass 12. However, this space may be blocked on the side facing the windshield glass 12. As sectioned orthogonally to the length direction illustrated by arrow C, a cross-section of a wiper arm 16A configured with such a space would exhibit a substantially cuboidal tube shaped structure. Alternatively, a member that covers (blocks) the recess in which the acceleration sensor 52 is installed may be applied in order to configure a space in which the side facing the windshield glass 12 is blocked. Applying a member to cover the recess enables the acceleration sensor 52 to be prevented from being directly exposed to wind and rain.

Together with the sensor signal wire, the protective cover 74 internally housing the sensor signal wire leads out from the recess inside the wiper arm 16A to the exterior of the wiper arm 16A at the base portion 42A of the wiper arm 16A. The connector 76A is configured capable of being connected to a connector 76B of a harness 88 on the wiper control circuit side.

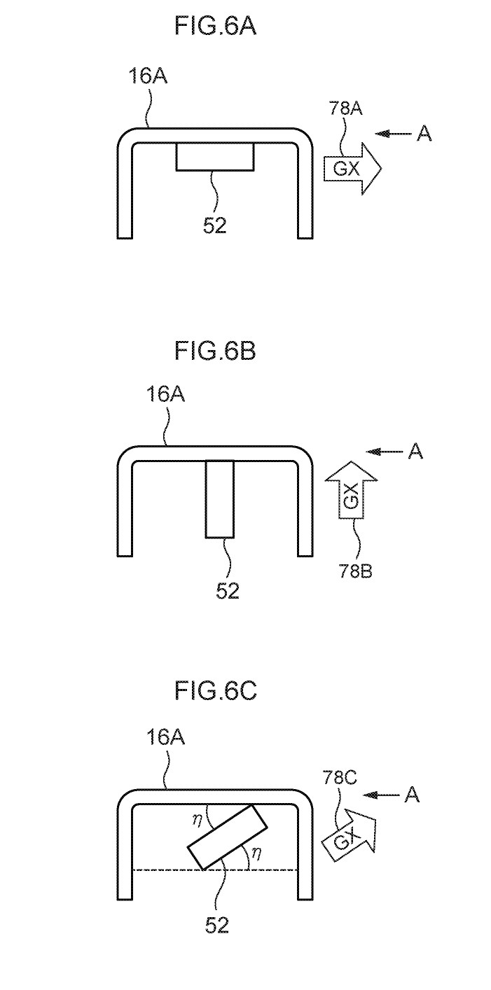

FIG. 6A to FIG. 6C are cross-sections of the wiper arm 16A sectioned along line B-B in FIG. 5, and illustrate various modes of installation of the acceleration sensor 52. There are various types of acceleration sensor 52, including electrostatic capacity sensors, piezoresistive sensors, or gas temperature distribution sensors, and any of these may be employed. Regardless of the acceleration sensor 52 type, there are restrictions to the directions in which acceleration detection is possible. For example, in the case of a uniaxial acceleration sensor, the sensor is capable of detecting acceleration in any one direction out of an X axis, a Y axis, or a Z axis with respect to a sensor body. Thus, in the present exemplary embodiment, the acceleration sensor 52 needs to be installed in a manner that enables effective detection of juddering.

FIG. 6A illustrates an example in which the acceleration sensor 52 is installed such that an acceleration detection direction 78A of the acceleration sensor 52 runs parallel to the surface of the windshield glass 12. In the case illustrated in FIG. 6A, it is possible to detect juddering occurring in the same direction as the direction in which the wiper blade 36A moves across the windshield glass 12.

FIG. 6B illustrates an example in which the acceleration sensor 52 is installed such that an acceleration detection direction 78B of the acceleration sensor 52 is perpendicular to the surface of the windshield glass 12. In the case illustrated in FIG. 6B, it is possible to detect juddering occurring in the direction perpendicular to the surface of the windshield glass 12.

FIG. 6C illustrates an example in which the acceleration sensor 52 is installed such that an acceleration detection direction 78C of the acceleration sensor 52 is inclined by an angle η with respect to the surface of the windshield glass 12. In the case illustrated in FIG. 6C, it is possible to detect composite vibration configured by juddering occurring in the same direction as the direction in which the wiper blade 36A moves across the windshield glass 12, and juddering occurring in the direction perpendicular to the surface of the windshield glass 12. The angle η may be any angle from 0° to 90°, and is decided by testing on actual equipment or the like. The angle η is also influenced by various factors such as the shape of the wiper arm 16A and constraints on the attachment position of the acceleration sensor 52, and so is preferably decided taking these various factors into consideration.

As long as the acceleration sensor 52 is able to effectively detect juddering occurring in the wiper blade 36A, the acceleration sensor 52 may be installed in a manner other than those illustrated in FIG. 6A to FIG. 6C. However, the acceleration sensor 52 is preferably installed in the space inside the wiper arm 16A, principally in order to protect the acceleration sensor 52. For example, if the acceleration sensor 52 were to be installed on the surface of the wiper arm 16A, there would be a concern of deterioration due to exposure to ultraviolet rays and wind and rain, and also a concern of damage from flying stones or like. Moreover, there would be a risk of the acceleration sensor 52 being damaged if a user were to inadvertently touch the acceleration sensor 52, and exposing the acceleration sensor 52 to the exterior would also be undesirable in terms of product appearance.

Even when installed in the recess inside the wiper arm 16A, if the acceleration sensor 52 were to be installed such that its acceleration detection direction was parallel to the length direction illustrated by arrow C in FIG. 5, it would be difficult to effectively detect juddering. When installed in such a manner, acceleration that causes the wiper arm 16A to extend or retract in the length direction would be detected, but since the wiper arm 16A is coupled to the rotation shaft 26 without any play therebetween, the body of the wiper arm 16A has high rigidity in its length direction. Thus, very little acceleration causing the wiper arm 16A to extend or retract in the length direction would be detected. Thus, in the present exemplary embodiment, the acceleration sensor 52 should be installed in a state in which the acceleration detection direction intersects the length direction of the wiper arm 16A.

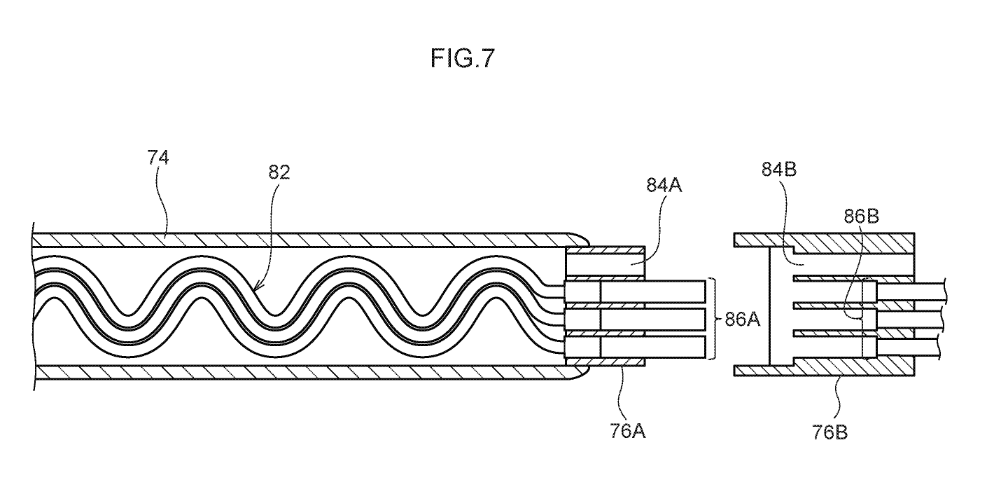

FIG. 7 is a schematic diagram illustrating an example of the protective cover 74 internally housing a sensor signal wire 82, as well as the connectors 76A, 76B. The protective cover 74 is configured by a flexible insulator such as synthetic rubber or a synthetic resin, and needs to have a strength and durability capable of withstanding bending at the hinge 38A.

The overall length of the sensor signal wire 82 inside the protective cover 74 is longer than the overall length of the protective cover 74. This is in order to prevent snapping due to bending at the hinge 38A or swinging of the wiper arm 16A. The overall length of the protective cover 74 is also preferably a dimension that allows for bending at the hinge 38A and swinging of the wiper arm 16A.

The sensor signal wire 82 is connected to a terminal 86A of the connector 76A. When the connector 76A is connected to the connector 76B on the wiper control circuit 10 side, the terminal 86A and a terminal 86B are electrically connected, and the acceleration sensor 52 and the wiper control circuit 10 are electrically connected as a result.

An air hole 84A that is in communication with the space inside the protective cover 74 is formed at the connector 76A. When the connector 76A is connected to the connector 76B, the air hole 84A is also in communication with an air hole 84B at the connector 76B. An interior space in the protective cover 74 is open to the exterior through the air holes 84A, 84B as a result.

When the hinge 38A is bent and extended due to lock-back, the placement direction of the protective cover 74 changes and the volume of the interior space of the protective cover 74 changes. Due to this change in volume, either air inside the protective cover 74 needs to be expelled from, or external air needs to be introduced to, the interior space of the protective cover 74. Moreover, when the air in the interior space of the protective cover 74 expands due to a rise in the air temperature, air needs to be expelled from inside the protective cover 74, and when the air temperature drops, external air needs to be introduced to the interior space of the protective cover 74. In the present exemplary embodiment, the interior space of the protective cover 74 is open to external air through the air holes 84A, 84B provided at the connectors 76A, 76B, thereby suppressing pressure changes from arising in the interior space of the protective cover 74 due to bending of the hinge 38A or a change in air temperature.

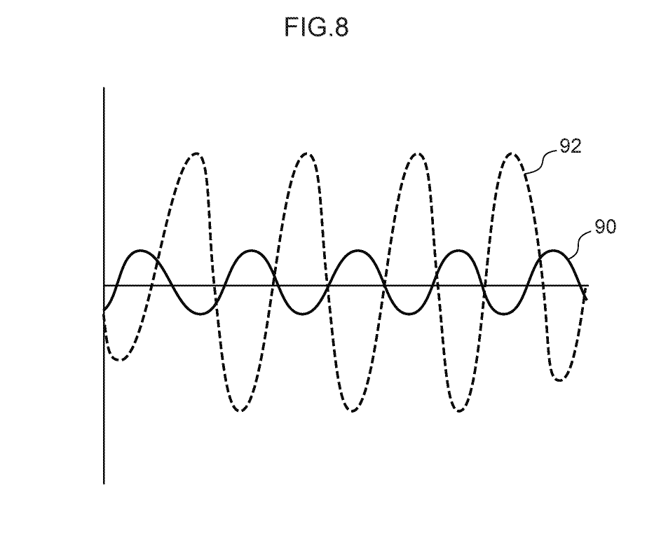

Explanation follows regarding operation of the present exemplary embodiment. FIG. 8 is a schematic diagram illustrating an example of a juddering waveform 90, and a voltage waveform 92 applied to the wiper motor 18 in order to suppress this juddering. The juddering waveform 90 is based on a waveform of a signal output from the acceleration sensor 52.

In order to suppress the juddering, the voltage applied to the wiper motor 18 is modulated so as be of opposite phase to the juddering waveform 90. As illustrated in FIG. 8, the voltage waveform 92 applied to the wiper motor 18 is substantially of opposite phase to the juddering waveform 90. In FIG. 8, when the juddering waveform 90 points downward, acceleration that impairs a wiping operation (acceleration in the opposite direction to the wiping operation direction) is occurring in the wiper blade 36A. The action caused by this acceleration is accordingly offset by raising the voltage applied to the wiper motor 18 so as to increase the rotation speed of the wiper motor 18. When the juddering waveform 90 points upward, acceleration that speeds up the wiping operation (acceleration in the same direction as the wiping operation direction) is occurring in the wiper blade 36A. The action caused by this acceleration is accordingly offset by lowering the voltage applied to the wiper motor 18 to suppress the rotation speed of the wiper motor 18.

In most cases, juddering has a frequency and amplitude that is inherent to the equipment in question. Thus, fixed values for the frequency and amplitude of the voltage waveform 92 for suppressing juddering are decided based on computer simulation and testing using actual equipment, and are stored in advance in the memory 48 as a predetermined frequency and amplitude.

In the present exemplary embodiment, when juddering has been detected, the voltage represented by the waveform 92 is generated in the drive circuit 56 by PWM control and applied to the wiper motor 18. The timing of the PWM control is set such that the voltage waveform 92 points upward when the juddering waveform 90 points downward. However, in cases in which it is difficult for the voltage waveform 92 to be completely opposite in phase to the juddering waveform 90 due to a lag in the operation of the link mechanism 14 of the wiper device 100, a delay in the switch operation of the respective transistors of the drive circuit 56, or the like, a voltage having a waveform that is substantially of opposite phase may be generated instead. A voltage having a waveform that is substantially of opposite phase to the juddering waveform 90 is still capable of suppressing juddering.

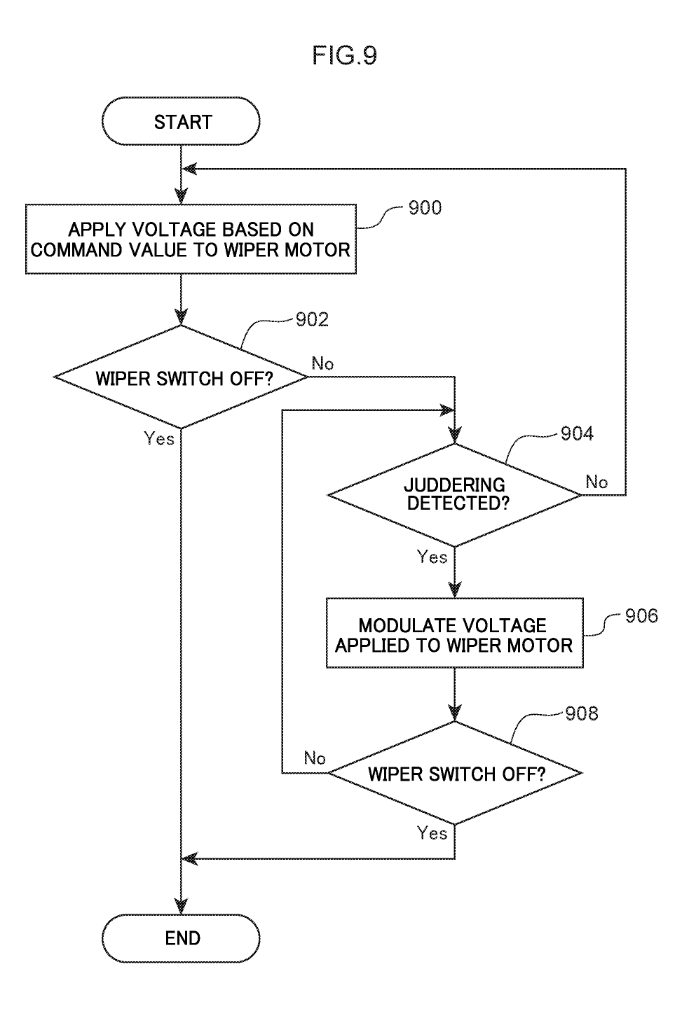

FIG. 9 is a flowchart illustrating an example of juddering suppression processing in the wiper device 100 according to the present exemplary embodiment. At step 900, a voltage is generated based on a command value input by the wiper switch 50, and applied to the wiper motor 18.

At step 902, determination is made as to whether or not the wiper switch 50 has been switched OFF. In cases in which determination is affirmative, processing is ended. In cases in which negative determination is made at step 902, at step 904, determination is made as to whether or not juddering has been detected. In cases in which affirmative determination is made at step 904, processing transitions to step 906, and in cases in which negative determination is made at step 904, processing transitions to step 900.

At step 906, the voltage to be applied to the wiper motor 18 is modulated as illustrated in FIG. 8, and the modulated voltage is then applied to the wiper motor 18. At step 908, determination is made as to whether or not the wiper switch 50 has been switched OFF, and in cases in which determination is affirmative, processing is ended. In cases in which negative determination is made at step 908, processing transitions to step 904.

As explained above, in the present exemplary embodiment, the acceleration sensor 52 is installed in the space inside the wiper arm 16A, and juddering is suppressed by generating a voltage with a waveform of opposite phase to the waveform of the change in acceleration detected by the acceleration sensor 52, and then applying this voltage to the wiper motor 18. The space inside the wiper arm 16A is isolated from the exterior, and is located at a position enabling easy detection of a change in the acceleration caused by vibration of the wiper arm 16A. The acceleration sensor can therefore be installed at an optimal position for suppressing vibration.

Moreover, in the present exemplary embodiment, the acceleration sensor can be installed at an optimal position for suppressing vibration by aligning the direction in which the acceleration sensor 52 detects acceleration with a direction in which acceleration of the wiper arm changes due to juddering.

The entire content of the disclosure of Japanese Patent Application No. 2016-223588 is incorporated by reference in the present specification.

All publications, patent applications and technical standards mentioned in the present specification are incorporated by reference in the present specification to the same extent as if each individual publication, patent application, or technical standard was specifically and individually indicated to be incorporated by reference.

1. A wiper device comprising:
a wiper arm including a recess, that is swung due to rotation of a wiper motor, and causing a wiper blade coupled to a leading end portion of the wiper arm to perform a wiping operation across a surface of a windshield glass;
an acceleration sensor that is installed in the recess of the wiper arm;
a drive circuit that generates a voltage to be applied to the wiper motor; and
a control circuit that controls the drive circuit such that a voltage is applied to the wiper motor so as to reduce a change in acceleration of the wiper arm, detected by the acceleration sensor.

2. The wiper device of claim 1, wherein the control circuit controls the drive circuit such that the voltage applied to the wiper motor is a voltage with a waveform of opposite phase to a waveform of the change in acceleration of the wiper arm detected by the acceleration sensor.

3. The wiper device of claim 1, wherein the recess is open along a length direction of the wiper arm at a side facing the windshield glass.

4. The wiper device of claim 3, further comprising a member that blocks an opening of the recess.

5. The wiper device of claim 1, wherein the acceleration sensor detects acceleration of the wiper arm in a direction intersecting a length direction of the wiper arm.

6. The wiper device of claim 1, wherein a signal wire that is covered by a protective member configured by an elastic body is connected to the acceleration sensor, is routed through the recess, extends outside the recess in a state covered by the protective member at a base portion of the wiper arm serving as a pivot point during swinging of the wiper arm, and is connected to the control circuit.

7. The wiper device of claim 6, wherein:
the wiper arm includes a foldable hinge located between the base portion and the leading end portion;
the acceleration sensor is installed in the recess between the base portion and the leading end portion; and
the protective member and the signal wire extend from the acceleration sensor past the hinge and the base portion to outside the recess, and the protective member and the signal wire have a length enabling a placement direction thereof inside the recess to change due to folding at the hinge or swinging of the wiper arm.

8. The wiper device of claim 6, wherein an overall length of the signal wire is longer than an overall length of the protective member.

9. The wiper device of claim 6, wherein:
an end portion of the signal wire covered by the protective member includes a connector that is connected to a signal wire extending from the control circuit;
the connector includes an air hole that is in communication with an interior space within the protective member; and
the interior space within the protective member is configured such that air is capable of passing through the air hole.
